(19) United States
(12) Patent Application Publication
(10) Pub. No.: US 2007/0110001 A1
(43) Pub. Date: May 17, 2007

(54) Wireless system, method for reconnection, and computer readable medium thereof

(76) Inventors: I-Cheng Ting, Tainan (TW); Chih-Ming Hsieh, Taipei (TW); Ji-Tsong Shieh, Ban-Chiao City (TW); Jian-Cheng Liao, Ping-Chen City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/320,264

(22) Filed: Dec. 28, 2005

(30) Foreign Application Priority Data
Nov. 11, 2005 (TW) 094139671

(51) Int. Cl. H04B 7/00; H04Q 7/00; H04Q 7/20

(52) U.S. Cl. 370/332; 455/464; 455/69

(57) ABSTRACT

A method for reconnecting a wireless system in an interference environment is provided. The wireless system comprises a host and an end device. The method searches an available communication channel between the host and the end device asynchronously. The end device informs the host of the condition of the qualified channels through the available communication channel. The host determines the most suitable channel from the qualified channels for reconnection between the host and the end device, and then informs the end device of the most suitable channel through the communication channel. The host and the end device hence switch to the most suitable channel.

### CROSS-REFERENCES TO RELATED APPLICATIONS

This application claims priority to Taiwan Patent Application No. 094139671 filed on Nov. 11, 2005.

### BACKGROUND OF THE INVENTION

1. Field of the Invention

The present invention relates to a wireless system, a method for reconnection, and a computer readable medium thereof for reconnection in an interference environment; specifically to a wireless system, a method for reconnection, and a computer readable medium thereof for reconnection in an interference environment by searching in asynchronous channels.

2. Descriptions of the Related Art

In a wireless network communication, some unexpected external interferences such as a radio frequency signal of a wireless phone or a microwave of a microwave oven may degrade transmission speed or even influence the connection quality of the wireless network heavily. Consequently, both connection stability and transmission speed of wireless networks have become key research topics in the communication field.

Prior reconnection methods for wireless systems are mainly used when a network is still connected. When transmitting data, an end device reports the status of available channels to a host. If the connection quality of the current channel in use is not good, the host informs the end device to change to a new channel. Both the host and the end device switch to this new channel simultaneously and reconnection is done.

FIG. 1 shows a mechanism of the prior art to reduce interference in a wireless network environment. The wireless network environment comprises a host 11, a beacon signal generator 13, and two end devices 17. The beacon signal generator 13 is arranged near the host 11 and its basic service area (BSA) 19 is the same as the basic service area of the host 11. The beacon signal generator 13 transmits a beacon signal periodically. When the wireless network environment is interfered, such as that the host 11 is located within the interference area of an interference source 15, the host 11 switches to some other channel. The beacon signal generator 13 transmits the channel changing information to the end devices 17. The end devices 17 then change the active channel to a highest or a lowest frequency band. After obtaining the information of the current channel changed by the host 11 from the beacon signal, the end devices 17 then switch to the current channel used by the host 11 and reconnect to the host 11.

Although the above mechanism can achieve reconnection while interference occurs in a wireless network, the wireless system has to operate with a beacon signal generator. Furthermore, only the environment of the host is considered during reconnection. If an external interference makes an end device unable to receive the beacon signal or the end device unable to switch to the selected new channel, the wireless system is incapable of reconnection. Consequently, considering available channels for both the host and the end device for reconnection becomes a key research issue in this field.

### SUMMARY OF THE INVENTION

An object of this invention is to provide a wireless system for communicating selectively through one of a plurality of channels, which comprise a first channel, a second channel and a third channel. The wireless system comprises an end device and a host, wherein the host initially communicates with the end device through the first channel. The host selects the second channel to communicate with the end device if the host determines that communication with the end device through the first channel is abnormal. The host selects the third channel to communicate with the end device if the host determines that a response from the end device is not received through the second channel. The end device selects the second channel to communicate with the host if the end device determines that communication with the host through the first channel is abnormal, and the end device selects the third channel to communicate with the host if the end device determines that a signal from the host is not received through the second channel. In this way, the wireless system can determine an available channel for communication between the host and the end device and reconnect without adding extra hardware components while the communication is broken.

Another object of this invention is to provide a reconnection method for a wireless system. The wireless system comprises a host and an end device, wherein the host initially communicates with the end device through a first channel, which is one of a plurality of channels used in the wireless system. The method comprises the steps of: (a) the host determining whether communication through the first channel is normal, if not, going to steps (b) and (c); (b) the host selecting a second channel to communicate with the end device, wherein the second channel is one of the plurality of channels; (c) the host determining whether a response from the end device is received through the second channel, if not, going to step (d); (d) the host selecting a third channel to communicate with the end device, wherein the third channel is one of the plurality of channels; (e) the end device determining whether communication through the first channel is normal, if not, going to steps (f) and (g); (f) the end device selecting the second channel to communicate with the host; (g) the end device determining whether a signal from the host is received through the second channel, if not, going to step (h); and (h) the end device selecting the third channel to communicate with the host. The method can determine an available channel for the connection between the host and the end device and rebuild the connection without adding extra hardware components while the connection is broken.

Yet a further object of this invention is to provide a computer readable medium for storing a computer program, which executes the above-mentioned method to rebuild connection.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 shows a mechanism of the prior art to reduce interference in a wireless network environment;

FIG. 2 is a diagram of a first embodiment of this invention;

FIG. 3 is a diagram of a second embodiment of this invention; and

FIG. 4 is a flowchart of a third embodiment of this invention.

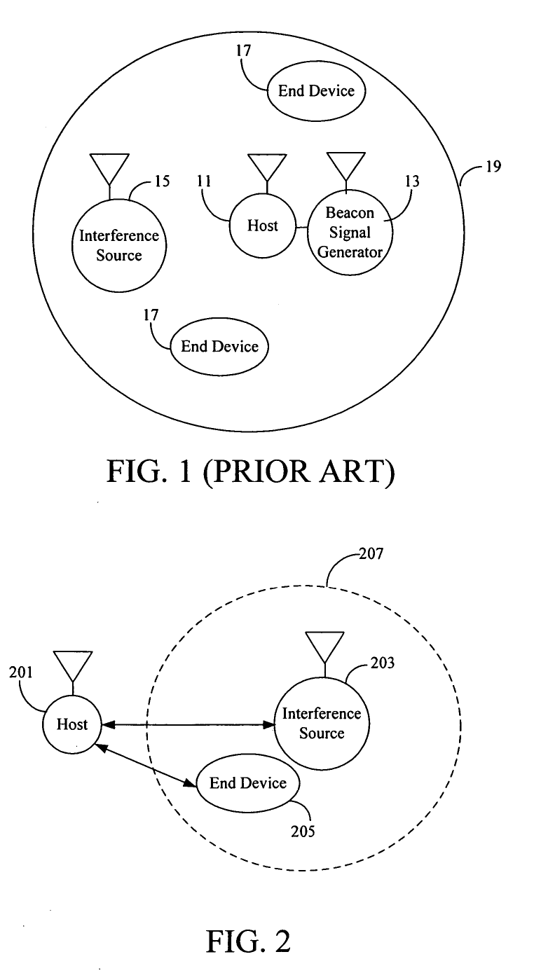

### DESCRIPTION OF THE PREFERRED EMBODIMENT

The first embodiment of this invention is shown in FIG. 2, which is a wireless system to recover communication in a wireless network environment to avoid interference of external signals. The embodiment communicates through one of a plurality of channels selectively. The wireless system comprises a host 201 and an end device 205. The wireless system is located within a wireless network constructed by an interference source 203. In this embodiment, the wireless system follows IEEE 802.15.4 standard and the software layer of the end device 205 is a Zigbee mode dividing its frequency domain into ten (915 MHz) or sixteen (2.4 GHz) channels by using a DSSS (Direct-Sequence Spread Spectrum) technique. Consequently, the plurality of channels can be ten or sixteen channels. If the software layer of the interference source 203 follows WiFi mode and IEEE 802.11 standard and divides its frequency domain into eleven channels by using the DSSS technique, the wireless system may be interfered.

Since the bandwidths of the WiFi and the IEEE 802.15.4 overlap partially, the end device 205 may be interfered by the interference source 203 so that disconnection from the host 201 occurs if the end device 205 lies within an interference range 207 of the interference source 203 as FIG. 2 shows. Consequently, the connection between the host 201 and the end device 205 should be rebuilt. Assuming that IEEE 802.15.4 standard of 2.4 GHz is used in the wireless network environment, the host 201 initially communicates with the end device 205 through a first channel. The host 201 selects a next channel (a second channel) to communicate with the end device 205 if it determines that the communication with the end device 205 through the first channel is abnormal by not receiving a confirmation signal from the end device 205. The host 201 selects a next channel (a third channel) to communicate with the end device 205 if it does not receive a response from the end device 205 through the second channel for a time period. If the host 201 does receive a response through the second channel, the host 201 records the available channels reported by the end device 205, wherein the available channels may include multiple channels among the sixteen channels. For example, if the end device 205 determines that the available channels under the interference of the interference source 203 include the second channel, the fourth channel, the eighth channel and the twelfth channel, the end device 205 reports the availability of the second channel, the fourth channel, the eighth channel and the twelfth channel when the host 201 switches to the second channel to communicate. The host 201 records the available channels and then selects one of them to rebuild the connection with the end device 205.

If the host 201 still does not receive a response from the end device 205 through the third channel, the host 201 keeps selecting a next channel to communicate with the end device 205 until receiving a response.

Similarly, the end device 205 selects a next channel (the second channel) to communicate with the host 201 if the end device 205 determines that the communication with the host 201 through the first channel is abnormal according to the condition of losing contact with the host 201 through the first channel. The end device 205 selects another next channel (the third channel) to communicate with the host 201 if it does not receive a signal from the host 201 through the second channel. If the end device 205 does not receive a signal from the host 201 through the third channel, the end device 205 keeps selecting a next channel to communicate with the host 201 until receiving a signal.

Before changing the communication channel to reconnect with the host 201, the end device 205 verifies the available channels among the sixteen channels, which are so-called clean channels for maintaining communication and will be reported to the host 201, i.e., the second channel, fourth channel, eighth channel and twelfth channel. It should be clarified that the clean channels are out of the interference or within the interference but not affecting the communication. After recording the available channels, the host 201 informs the end device 205, for example, to switch to the fourth channel through the second channel if the host 201 confirms that the fourth channel is the most suitable channel for communication. The host 201 then communicates with the end device 205 through the fourth channel.

When the host 201 tries to connect with the end device 205 through some channel, it stays at the channel for a specific amount of time which is twice as long as the required amount of time for the end device 205 to switch the whole sixteen channels. For example, if the required time to switch a channel is 0.5 second for the end device 205, the required time for switching the whole sixteen channels is 8 seconds. Consequently, the host 201 stays at a channel for sixteen seconds waiting for a response so that the host 201 will not miss the chance to receive the response from the end device 205.

The host 201 and the end device 205 can transmit a confirmation signal to each other within a specific period of time to determine whether the communication is normal or not. If a response message is not received after transmitting n successive confirmation signals, the communication is regarded as disconnection. For example, the specific period of time may be five seconds and the number n for transmitting the confirmation signals is six times. So if there is no response message received after thirty seconds, the communication between the host 201 and the end device 205 is regarded as disconnection. The host 201 and the end device 205 then perform the aforementioned processes to recover the connection independently.

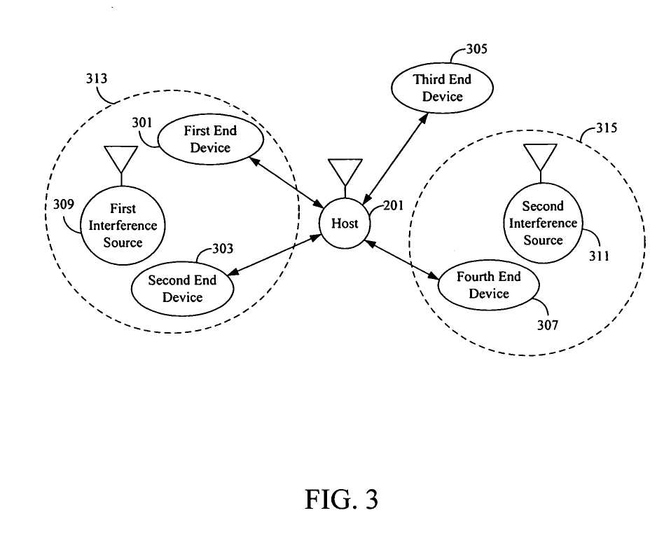

The second embodiment of this invention is shown in FIG. 3, which is a wireless system in a wireless network environment able to recover communication in order to avoid or to reduce the influence of interference of external signals. The difference between this embodiment and the first embodiment is that the wireless system comprises several end devices. This embodiment communicates selectively through one of a plurality of channels which comprises a first channel, a second channel and a third channel. It should be clarified that these three channels are used herein only for explanation. The actual number of the plurality of channels in practice is not restricted to three. The wireless system comprises a first end device 301, a second end device 303, a third end device 305, a fourth end device 307 and a host 201. The wireless network environment is interfered by a first interference source 309 and a second interference source 311. In this embodiment, the wireless system also follows IEEE 802.15.4 standard of the 2.4 GHz and the software layers of the interference sources 309 and 311 follow WiFi mode.

The communications between the host 201 and the first, second and fourth end devices 301, 303 and 307 may be abnormal or even totally broken since they are located either within an interference area 313 of the first interference source 309 or within an interference area 315 of the second interference source 311. Consequently, the host 201 should reconnect with the first, second, and fourth end devices 301, 303 and 307. In this embodiment, the host 201 initially communicates with the first, second, third and fourth end devices 301, 303, 305 and 307 through the first channel. As shown in FIG. 3, both the first end device 301 and the second end device 303 are located within the interference area 313 and the fourth end device 307 is located within the interference area 315. The host 201 selects a next channel, e.g., the second channel to try communicating with the first, second and fourth end devices 301, 303 and 307 if determining that the communications with the first, second and fourth end devices 301, 303 and 307 through the first channel are abnormal. The third end device 305, which is able to communicate with the host 201 through the first channel, keeps using the first channel for communication. The host 201 selects a next channel, e.g., the third channel for communication if determining that no response is received from the first, second and fourth end devices 301, 303 and 307 through the second channel. If the host 201 is aware that the communication with the first end device 301 may be rebuilt through the second channel by receiving a response from the first end device 301, the host 201 communicates with the first end device 301 through the second v channel temporarily. In addition, the response transmitted by the first end device 301 also records the available channels detected by the end device 301.

Similarly, if any end device determines that the communication with the host 201 through the first channel is abnormal, the end device selects a next channel, e.g., the second channel to try communicating with the host 201. If the end device determines that no signal is received from the host 201 through the second channel, it selects a further next channel, e.g., the third channel to try communicating with the host 201.

Before selecting the first, second, or third channel to communicate with the host 201, the first, second, third and fourth end devices 301, 303, 305 and 307 respectively verify the available channels and then inform the host 201 of the clean channels for maintaining communication. Table 1 shows the temporary connection channel and the available channels for each end device 301, 303, 305 and 307 to communicate with the host 201 while interference occurs. For example, the temporary connection channel for the second end device 303 to communicate with the host 201 is the twelfth channel and the available channels for the second end device 303 are from the third channel to the thirteenth channel. After receiving these reports, the host 201 determines that one of the most suitable available channel is the fourth channel because the fourth channel is one of the common available channels for all the end devices 301, 303, 305 and 307. Then the host 201 informs the first, second, third and fourth end devices 301, 303, 305 and 307 to switch to the fourth channel for reconnection through the eleventh, the twelfth, the first and the seventh channels, respectively. It should be noted that the host 201 selects either one of the common available channels for all of the end devices 301, 303, 305 and 307 or one of the channels available for the biggest number of the end devices 301, 303, 305 and 307.

TABLE 1

| | | Connection |
|---|---|---|
| End Device | Available Channels | Channel |
| First | 4-15 | 11 |
| Second | 3-13 | 12 |
| Third | 1-16 | 1 |
| Fourth | 2-13 | 7 |

Although the wireless system in the second embodiment simply shows four end devices and two interference sources, people skilled in this field can easily deduce an embodiment of a wireless system comprising any number of end devices and any number of interference sources.

The third embodiment of the subject invention is a reconnection method for a wireless system which comprises a host and an end device. The host initially communicates with the end device through a first channel. At least one of the host and the end device is influenced by an interference source.

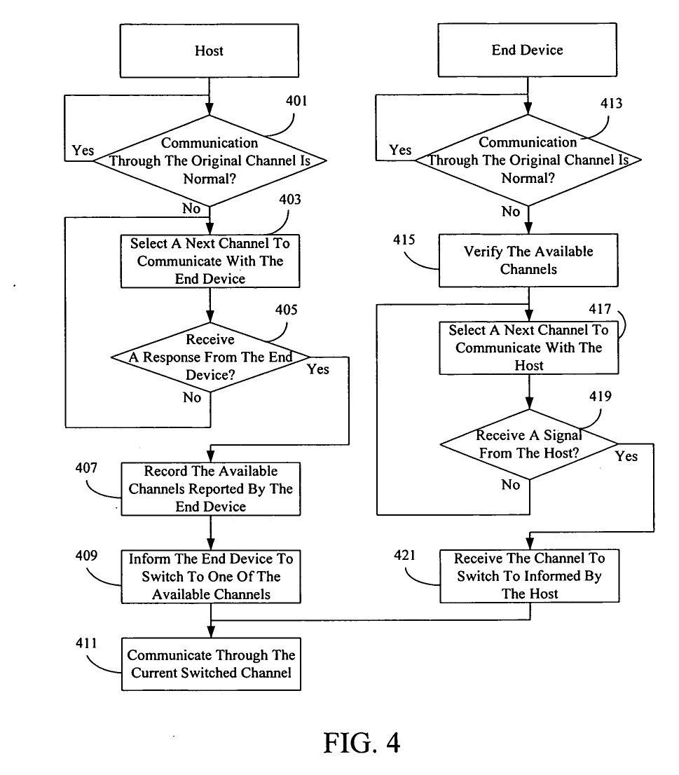

The method for reconnection is shown in FIG. 4. In step 401, the host determines whether the communication through the original channel, i.e., the first channel is normal or not. If yes, step 401 is repeated after a specific amount of time. If not, step 403 is executed in which the host selects a next channel, e.g., a second channel to communicate with the end device. Step 405 is then executed wherein the host determines whether a response is received from the end device through the second channel. If not, the method returns to step 403 and the host selects a further next channel, e.g., a third channel to communicate with the end device. If yes, step 407 is executed wherein the host records the available channels reported by the end device. Step 409 is then executed wherein the host informs the end device to switch to one channel, namely a fourth channel, from the available channels. Step 411 is executed wherein the host communicates with the end device through the current switched channel, i.e., the fourth channel and the process of reconnection of the host ends.

Similarly, the end device determines whether the communication through the original channel is normal or not in step 413. If yes, step 413 is repeated after a specific amount of time. If not, step 415 is executed wherein the end device verifies the available channels under the interference. Step 417 is then executed wherein the end device selects a next channel to communicate with the host. Step 419 is then executed wherein the end device determines whether a signal is received from the host through the channel. If not, the method returns to step 417 wherein the end device selects a further next channel to communicate with the host. If yes, step 421 is executed wherein the end device receives a certain channel informed by the host through the channel selected in step 417. Then step 411 is executed wherein the host communicates with the end device through the certain channel and the process of reconnection of the end device ends.

More specifically, if the end device determines that communication through the original channel is abnormal in step 413 and the host does not determine that communication through the original channel is abnormal yet in step 401, the end device independently executes step 415 to determine the available channels, and then executes step 417 and step 419 to find out one channel for communicating with the host. The host is informed of the available channels. The host then executes step 407, step 409 and step 411.

The method may be executed by using a computer readable medium which stores a computer program. The computer program comprises code to execute the above-mentioned steps of the method. The computer readable medium can be a floppy disk, a hard disk, an optical disc, a flash disk, a tape, an internet accessible database or any storage medium with a similar functionality of storage which is easily thought by people skilled in the field.

The first, the second, the third and the fourth channels herein are only intended to indicate that they are different channels. That means, for example, the second channel selected by the host and the second channel selected by the end device are not restricted to the same channel.

According to the above descriptions, the subject invention can achieve reconnection when either the host or the end device loses contact, or both the host and the end device lose contact. The subject invention may be implemented without adding extra hardware components.

The above embodiments are used as the examples of the subject invention and used to explain the technical characters of the subject invention and are not used to limit the range of the subject invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless system for communicating selectively through one of a plurality of channels, the plurality of channels comprising a first channel, a second channel and a third channel, the wireless system comprising:
an end device; and
a host for initially communicating with the end device through the first channel;
wherein the host selects the second channel to communicate with the end device if determining that communication with the end device through the first channel is abnormal, and the host selects the third channel to communicate with the end device if determining a response from the end device is not received through the second channel;
wherein the end device selects the second channel to communicate with the host if determining that communication with the host through the first channel is abnormal, and the end device selects the third channel to communicate with the host if determining a signal from the host is not received through the second channel.

2. The wireless system as claimed in claim 1, wherein the end device detects available channels among the plurality of channels before selecting the second channel to communicate with the host.

3. The wireless system as claimed in claim 2, wherein if the host receives the response, the host records the available channels reported by the end device.

4. The wireless system as claimed in claim 3, wherein the host informs the end device to switch to a fourth channel through the second channel, the fourth channel is one of the available channels, and then the host communicates with the end device through the fourth channel.

5. The wireless system as claimed in claim 4, further comprising a plurality of end devices, the end device being one of the plurality of end devices, wherein the fourth channel is one of the common available channels for all of the plurality of end devices.

6. The wireless system as claimed in claim 4, further comprising a plurality of end devices, the end device being one of the plurality of end devices, wherein the fourth channel is one of the channels available for the biggest number of the plurality of end devices.

7. The wireless system as claimed in claim 1, wherein the host stays at the second channel for a specific amount of time before selecting the third channel to communicate with the end device, and the specific amount of time is twice as long as a required amount of time for the end device to switch the plurality of channels.

8. A method for a wireless system to recover communication, the wireless system comprising a host and an end device, the host initially communicating with the end device through a first channel, the first channel being one of a plurality of channels used in the wireless system, the method comprising:
(a) the host determining whether communication through the first channel is normal, if not, going to steps (b) and (c);
(b) the host selecting a second channel to communicate with the end device, wherein the second channel is one of the plurality of channels;
(c) the host determining whether a response from the end device is received through the second channel, if not, going to step (d);
(d) the host selecting a third channel to communicate with the end device, wherein the third channel is one of the plurality of channels;
(e) the end device determining whether communication through the first channel is normal, if not, going to steps (f) and (g);
(f) the end device selecting the second channel to communicate with the host;
(g) the end device determining whether a signal from the host is received through the second channel, if not, going to step (h); and
(h) the end device selecting the third channel to communicate with the host.

9. The method as claimed in claim 8, further comprising:
(i) the end device detecting available channels among the plurality of channels.

10. The method as claimed in claim 9, wherein if yes in step (c), the method further comprises:
(j) the host recording the available channels reported by the end device.

11. The method as claimed in claim 10, further comprising:
(k) the host informing the end device to switch to a fourth channel through the second channel, wherein the fourth channel is one of the available channels; and
(l) the host communicating with the end device through the fourth channel.

12. The method as claimed in claim 11, wherein the wireless system comprises a plurality of end devices, the end device is one of the plurality of end devices, and the fourth channel is one of the common channels available for all of the plurality of end devices.

13. The method as claimed in claim 11, wherein the wireless system comprises a plurality of end devices, the end device is one of the plurality of end devices, and the fourth channel is one of the channels available for the biggest number of the plurality of end devices.

14. The method as claimed in claim 8, wherein in step (c) the host stays at the second channel for a specific amount of time, and the specific amount of time is twice as long as a required amount of time for the end device to switch the plurality of channels.

15. A computer program product for storing a computer program to execute a method for a wireless system to recover communication, the wireless system comprising a host and an end device, the host initially communicating with the end device through a first channel, the first channel being one of a plurality of channels used in the wireless system, the computer program comprising:
code A for the host to determine whether communication through the first channel is normal, if not, executing code B and C;
code B for the host to select a second channel to communicate with the end device, wherein the second channel is one of the plurality of channels;
code C for the host to determine whether a response from the end device is received through the second channel, if not, executing code D;
code D for the host to select a third channel to communicate with the end device, wherein the third channel is one of the plurality of channels;
code E for the end device to determine whether communication through the first channel is normal, if not, executing code F and G;
code F for the end device to select the second channel to communicate with the host;
code G for the end device to determine whether a signal from the host is received through the second channel, if not, executing code H; and
code H for the end device to select the third channel to communicate with the host.

16. The computer program product as claimed in claim 15, wherein the computer program further comprises:
code I for the end device to detect available channels among the plurality of channels.

17. The computer program product as claimed in claim 16, wherein if yes determined by code C, the computer program further comprises:
code J for the host to record the available channels reported by the end device.

18. The computer program product as claimed in claim 17, wherein the computer program further comprises:
code K for the host to inform the end device to switch to a fourth channel through the second channel, wherein the fourth channel is one of the available channels; and
code L for the host to communicate with the end device through the fourth channel.

19. The computer program product as claimed in claim 18, wherein the wireless system comprises a plurality of end devices, the end device is one of the plurality of end devices, and the fourth channel is one of the common channels available for all of the plurality of end devices.

20. The computer program product as claimed in claim 18, wherein the wireless system comprises a plurality of end devices, the end device is one of the plurality of end devices, and the fourth channel is one of the channels available for the biggest number of the plurality of end devices.

21. The computer program product as claimed in claim 15, wherein code C drives the host to stay at the second channel for a specific amount of time, and the specific amount of time is twice as long as a required time for the end device to switch the plurality of channels.
